(19) United States
(12) Patent Application Publication
(10) Pub. No.: US 2005/0235258 A1
(43) Pub. Date: Oct. 20, 2005

(54) Method, plug-in and program product for customizing java bean properties

(75) Inventor: James R. Wason, Tuxedo, NY (US)

Correspondence Address: HOFFMAN WARNICK & D'ALESSANDRO, LLC, 75 STATE STREET, 14TH FL, ALBANY, NY, 12207, US

(73) Assignee: International Business Machines Corporation, Armonk, NY (US)

(21) Appl. No.: 10/827,748

(22) Filed: Apr. 20, 2004

(51) Int. Cl. G06F 9/44

(52) U.S. Cl. 717/110

(57) ABSTRACT

The present invention provides an editor plug-in that allows Java Bean property values to be edited in an Integrated Development Environment (IDE) that is based on the Eclipse standard. The system of the present invention also provides interoperability for customer editors and the like between a IDE that is based on the Java Bean standard and an IDE that is based on the Eclipse standard.

### FIELD OF THE INVENTION

In general, the present invention relates to a method, plug-in and program product for customizing Java Bean properties. Specifically, the present invention allows Java Bean property values to be edited within an Integrated Development Environment (IDE) that is based on the Eclipse standard.

### BACKGROUND OF THE INVENTION

As the use of computer software has become more pervasive, the evolution of programming languages such as Java has accelerated. Traditionally, the technique to provide customizations for Java applications has been through the use of Java Beans. To this extent, the Java Bean standard provides a well defined description of how to do this. Moreover, various applications such as VisualAge for Java, which is commercially available from International Business Machines Corp. of Armonk, N.Y., provide facilities for development using the Java Bean standard. Furthermore, the Enterprise Application Developer Platform (EADP) was implemented on VisualAge using the Java Beans standard. EADP provides customization through the use of custom editors developed within that standard.

However, as the evolution of programming continues, VisualAge is progressively being replaced by WebSphere Studio Application Developer (WSAD), which is also commercially available from International Business Machines Corp. In general, WSAD is based on the Eclipse standard. Unfortunately, although WSAD has pretensions as a robust Java development environment, it does not provide a facility equivalent to the Java Beans environment provided by VisualAge. For example, there is currently no way for a developer to edit/customize Java Bean properties in WSAD. Specifically, in an Integrated Development Environment (IDE) such as VisualAge or WSAD, Java code is developed in a Workspace. However, there is also a set of Java code that operates that Workspace. In VisualAge, these environments are integrated, so that code developed in the Workspace is available for use during Java Bean customization. In WSAD this is not the case. The crucial difference is that custom editors for a bean may have to look up related values in order to work properly. For example, the EADP custom editor for computed columns needs to know which columns are available as source columns. The EADP editor does this by examining the surrounding code for the application that it is customizing. Such classes are typically available during bean customization in VisualAge, but not in WSAD.

Another problem is that Java Beans define a well organized pattern for providing custom property editors for customizing properties. As indicated above, WSAD uses the Eclipse standard for property editors. This is also well defined, but completely different than those developed under the Java Bean standard. As such, custom editors developed for the Java Bean standard (e.g., for VisualAge) cannot currently be used “as is” within WSAD. Since developers have heretofore spent considerable time and resources developing custom editors for use under the Java Bean standard, it would be highly advantageous to provide interoperability (e.g., for editors) between IDEs that are based on the different standards.

In view of the foregoing, there exists a need for a method, plug-in and program product for editing Java Bean properties. Specifically, a need exists for a system that allows Java Bean property values to be customized/edited in an IDE that is based on the Eclipse standard (e.g., such as WSAD). A further need exists for such a system that provides interoperability for custom editors and the like between IDEs based on the Java Bean standard (e.g., such as VisualAge) and IDEs based on the Eclipse standard.

### SUMMARY OF THE INVENTION

In general, the present invention provides a method, plug-in and program product for editing/customizing Java Bean properties. Specifically, the present invention provides an editor plug-in that allows Java Bean property values to be edited in an Integrated Development Environment (IDE) that is based on the Eclipse standard. The system of the present invention also provides interoperability for customer editors and the like between an IDE that is based on the Java Bean standard and an IDE that is based on the Eclipse standard. To this extent, under the present invention, a plug-in loader can be assigned to a Java Bean code editor (within the IDE that is based on the Eclipse standard). Once the plug-in loader is assigned, code for a Java Bean encloser is accessed and loaded in a workspace of the IDE using the plug-in loader. Thereafter, Java Bean property values are determined from the code for the Java Bean encloser. Then, the property values can be edited using the Java Bean code editor, and applied to the code for the Java Bean encloser.

A first aspect of the present invention provides a method for editing Java Bean properties, comprising: assigning a plug-in loader to a Java Bean code editor; accessing code for a Java Bean encloser in a workspace using the plug-in loader; determining Java Bean property values from the code for the Java Bean encloser in the workspace; and editing the Java Bean property values using the Java Bean code editor, and applying the edited Java Bean property values to the code for the Java Bean encloser.

A second aspect of the present invention provides a method for customizing Java Bean properties, comprising: assigning a plug-in loader to a Java Bean code editor; accessing code for a Java Bean encloser in a workspace of an Integrated Development Environment (IDE) that is based on an Eclipse Standard using the plug-in loader; determining Java Bean property values from the code for the Java Bean encloser in the workspace; editing the Java Bean property values using the Java Bean code editor, and applying the edited Java Bean property values to the code for the Java Bean encloser; and storing results of the editing.

A third aspect of the present invention provides an editor plug-in for editing Java Bean properties within an Integrated Development Environment (IDE) that is based on an Eclipse standard, comprising: a loader assignment system for assigning a plug-in loader to a Java Bean code editor; a code access system for accessing code for a Java Bean Encloser in a workspace using the plug-in loader; a property determination system for determining Java Bean property values from the code for the Java Bean encloser in the workspace, wherein the Java Bean property values can be edited within the Integrated Development Environment (IDE) using the Java Bean code editor; and a value application system for applying edited Java Bean property values to the code for the Java Bean encloser.

A fourth aspect of the present invention provides a program product stored on a recordable medium for editing Java Bean properties within an Integrated Development Environment (IDE) that is based on an Eclipse standard, which when executed comprises: program code for assigning a plug-in loader to a Java Bean code editor; program code for accessing code for a Java Bean Encloser in a workspace using the plug-in loader; program code for determining Java Bean property values from the code for the Java Bean encloser in the workspace, wherein the Java Bean property values can be edited within the Integrated Development Environment (IDE) using the Java Bean code editor; and program code for applying edited Java Bean property values to the code for the Java Bean encloser.

Therefore, the present invention provides a method, plug-in and program product for editing/customizing Java Bean properties.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts a system for editing/customizing Java Bean properties according to the present invention.

FIG. 2 depicts a method flow diagram according to the present invention.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### BEST MODE FOR CARRYING OUT THE INVENTION

For convenience purposes, the Best Mode for Carrying Out the Invention will have the following sections:
I. General Description
II. Editor Plug-in
   I. General Description

As indicated above, the present invention provides a method, plug-in and program product for editing/customizing Java Bean properties. Specifically, the present invention provides an editor plug-in that allows Java Bean property values to be edited in an Integrated Development Environment (IDE) that is based on the Eclipse standard. Prior to the present invention, customization of Java Bean properties was possible only within an IDE that was based on the Java Bean standard. As IDEs based on the Java Bean standard (e.g., VisualAge) are phased out, the teachings of the present invention provide significant advantages. In addition, the system of the present invention also provides interoperability for customer editors and the like between a IDE that is based on the Java Bean standard and an IDE that is based on the Eclipse standard. To this extent, under the present invention, a plug-in loader can be assigned to a Java Bean code editor (within the IDE that is based on the Eclipse standard). Once the plug-in loader is assigned, code for a Java Bean encloser is accessed, and loaded in a workspace of the IDE using the plug-in loader. Thereafter, Java Bean property values are determined from the code for the Java Bean encloser. Then, the property values can be edited using the Java Bean code editor, and applied to the code for the Java Bean encloser.

It should be understood that the Java Bean Standard and the more recent Eclipse standard are two specifications that are well known to those of ordinary skill in the art. As such, the details thereof will not be discussed herein.

Moreover, before discussing the invention in detail, some terminology and background information will be established. In general, bean property customization involves the interaction of three entities, namely, an encloser, a bean, and a property. The bean is an attribute of the encloser, and the property is an attribute of the bean. Within Enterprise Application Developer Platform (EADP), a common pattern is that the encloser is an application specific child of a base EADP class that defines the bean as an attribute. These children typically acquire their application specific characteristics through bean customization. What is customized is the properties of the bean in the context of the encloser.

The Java Bean standard/specification provides a bean information class, which specifies which attributes of the bean class can be customized, and what bean property editor to use for the customization. This bean property editor may in turn specify a special editor to present options for the property customization. Within EADP these facilities are used extensively, and the custom editors may be called upon to present data from other areas of the application. A simple example of a custom editor within EADP is the custom editor for computed columns, where the encloser is an child of EADPApplicationClass, the bean is an instance of EADPDAManager, and the property to be customized is computed columns. Each child of EADPApplicationClass is associated with a particular database table, and the computed column editor should be able to present the columns from that table as source columns for the formula for the new computed field. To this extent, the editor also should know the existing value of the property within the encloser in order to be able present what computed columns have been defined.

A more complicated example is the editor for the quick views property (again of the EADPDAManager bean with a child of EADPApplicationClass as the encloser). Quick view relationships are a special type of database relationship defined in EADP, for example, from a customers table to an orders table. The two tables would be linked by customer number, and the source table, would provide more customer data to the orders application class (such as customer name) by means of the quick view relationship. The columns from the customer table available to the child of EADPApplicationClass for the orders table (the OrdersApplicationClass) is determined by customizing the quick views property. The custom editor for quick views needs to be able to display which source columns from the customers table are available, and it does this by instantiating an instance of the application class for customers (the CustomersApplicationClass). This is not the encloser for the bean (the encloser is the OrdersApplicationClass) so the custom editor needs the capability to load related classes during its processing. It is the ability to do this that makes EADP bean customizations uniquely powerful.

II. Editor Plug-In

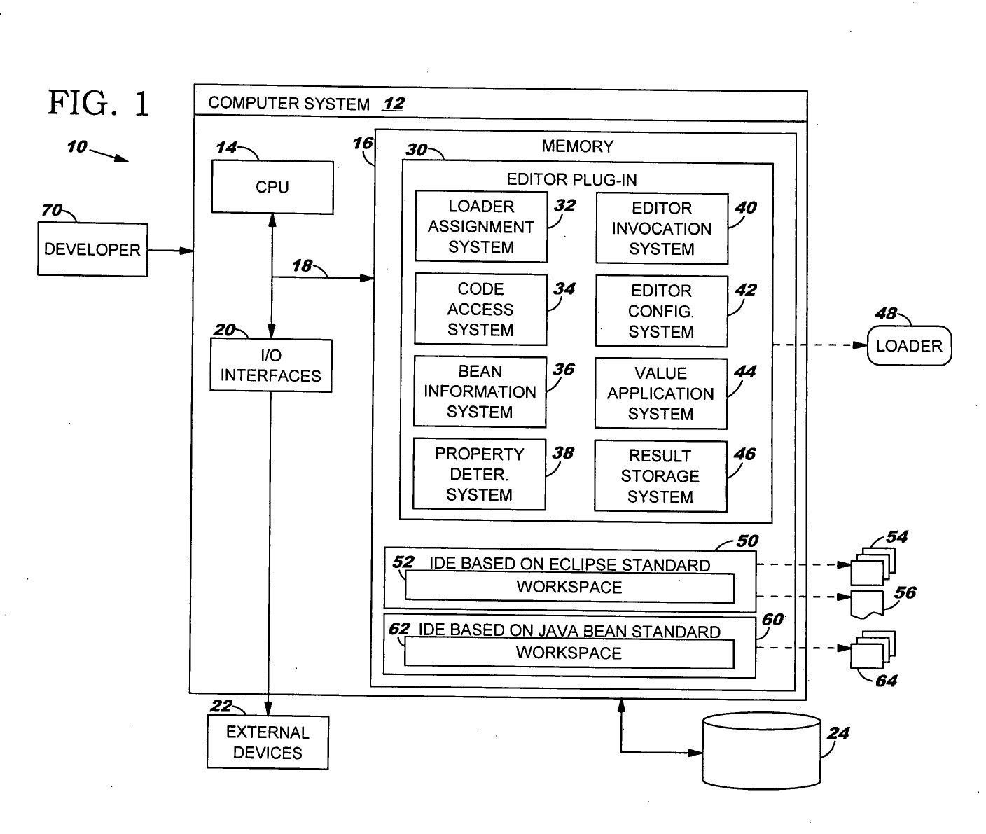

Referring now to FIG. 1, a system 10 for editing/customizing Java Bean property values in an Integrated Development Environment (IDE) that is based on the Eclipse standard is shown. As depicted, system 10 includes computer system 12 that is intended to represent any type of computerized device capable of carrying out the functions described below. To this extent, computer system 12 could be a workstation, a client, a server, etc. Furthermore, the teachings of the present invention could be implemented on a free-standing system such as computer system 12, over any type of network (not shown) such as the Internet, a local area network (LAN), a wide area network (WAN), a virtual private network (VPN), etc.

In the case of the latter, developer 70 would likely operate a client or other type of device to communicate with computer system 12 over the network. Such communication could occur via a direct hardwired connection (e.g., serial port), or via an addressable connection that may utilize any combination of wireline and/or wireless transmission methods. Moreover, conventional network connectivity, such as Token Ring, Ethernet, WiFi or other conventional communications standards could be used. Still yet, connectivity could be provided by conventional TCP/IP sockets-based protocol.

In any event, computer system 12 generally comprises central processing unit (CPU) 14, memory 16, bus 18, input/output (I/O) interfaces 20, external devices/resources 22 and storage unit 24. CPU 14 may comprise a single processing unit, or be distributed across one or more processing units in one or more locations, e.g., on a client and server. Memory 16 may comprise any known type of data storage and/or transmission media, including magnetic media, optical media, random access memory (RAM), read-only memory (ROM), a data cache, etc. Moreover, similar to CPU 14, memory 16 may reside at a single physical location, comprising one or more types of data storage, or be distributed across a plurality of physical systems in various forms.

I/O interfaces 20 may comprise any system for exchanging information to/from an external source. External devices/resources 22 may comprise any known type of external device, including speakers, a CRT, LCD screen, handheld device, keyboard, mouse, voice recognition system, speech output system, printer, monitor/display, facsimile, pager, etc. Bus 18 provides a communication link between each of the components in computer system 12 and likewise may comprise any known type of transmission link, including electrical, optical, wireless, etc.

Storage unit 24 can be any system (e.g., database) capable of providing storage for information under the present invention. Such information could include, for example, Java Bean properties, editors, class loaders, etc. As such, storage unit 24 could include one or more storage devices, such as a magnetic disk drive or an optical disk drive. In another embodiment, storage unit 24 includes data distributed across, for example, a local area network (LAN), wide area network (WAN) or a storage area network (SAN) (not shown). Although not shown, additional components, such as cache memory, communication systems, system software, etc., may be incorporated into computer system 12.

Shown in memory 16 of computer system is EADP property editor plug-in (hereinafter editor plug-in 30), IDE based on the Eclipse standard 50 (e.g., Websphere Studio Application Developer “WSAD”) and IDE based on the Java Bean standard (e.g., VisualAge). It should be understood that computer system 12 need not include both IDEs 50 and 60. Rather, the present invention could function with only editor plug-in 30 and IDE 50 on computer system 12. Furthermore, although below IDE 50 will be discussed with reference to WSAD and IDE 60 will be discussed with reference to VisualAge, this is for illustrative purposes only and need not be the case. In contrast, IDE 50 could be any IDE based on the Eclipse standard, while IDE 60 could be any IDE based on the Java Bean standard.

In general, editor plug-in 30 allows Java Bean properties to be edited/customized in IDE 50. Editor plug-in 30 also provides interoperability between IDE 60 and IDE 50 so that, for example, custom editors 64 developed for IDE 60 can be used within IDE 50. As shown, editor plug-in 30 includes loader assignment system 32, code access system 34, bean information system 36, property determination system 38, editor invocation system 40, editor configuration system 42, value application system 44 and result storage system 46.

Loader assignment system 32 generally allows a plug-in loader 48 to be assigned to a Java Bean code editor 54 of IDE 50. Once loader 48 has been assigned, code access system 34 will use loader 48 to load/access code for a Java Bean encloser within a workspace 52 of Integrated Development Environment (IDE) 50. Specifically, the assigned loader 48 will load the classes of Java Bean code whose properties are desired to be edited or customized. As discussed above, Java provides a certain hierarchy of classes. For example, on a hierarchical tree, a Java Bean property would be a child of a Java Bean, while the Java Bean would be a child of a Java Bean encloser. Similarly, the Java Bean encloser would be a child of a class. Under the present invention, when developer 70 desires to customize one or more properties of a Java Bean, loader 48 will load the code for the corresponding encloser.

With specific respect to the illustrative embodiment depicted in FIG. 1, WSAD uses the Eclipse standard, and provides classes and methods that allow access of files in the WSAD Workbench associated to workspace 52 in IDE 50. Within Java, code is organized into classes grouped into packages. Within WSAD these packages are further grouped into projects. There is an interface provided by Eclipse that allows for the access of files associated to a project, given that project, and in particular that interface allows the access of the class file (file extension class) for a class in that project. This class file can be used as the input for loading the class into the Java runtime environment so that the values of the attributes of that class can be determined, and methods of that class can be invoked. The EADP Property Editor for WSAD can operate as an editor plug-in 30 which provides a special editor for files with the extension Java (these are the source code files in the WSAD workspace). When editor plug-in 30 is invoked, it receives as an input the Eclipse class (an instance of IFile) for the source code that was selected (this is the encloser). This IFile instance has as an attribute the current project, which is passed to the constructor for the EADP Plug-in Class Loader 48.

The EADP Plug-in Class Loader 48 constructor takes as parameters the “base loader” (the system provided class loader) and the current WSAD project. When called by code access system 34 to load an encloser class, it attempts first to load that class using the base loader. If that fails, it checks to see if it has already obtained the class file for that class. If not, it uses the name of the class, and the current project to find the class file for that class in the workspace 52. This same technique is used to load any other subsidiary classes or interfaces that may be called out through inheritance, implementation, or usage as the class is loaded. The net result is that classes defined in the workspace 54 are available to the plug-in editors through the facilities of the plug-in loader 48.

Java Bean customization for a property is defined (according the Java Bean standard) by providing a property editor that implements the interface Java.beans.PropertyEditor. The class provided by Java as a base class implementing this interface is Java.beans.PropertyEditorSupport. The interface includes a method to provide a special editor which must be a child of Java.awt.Panel. EADP specializes this standard by requiring that its property editors inherit from EADPBeanEditor (which inherits from PropertyEditorSupport) and that the associated special editors inherit from EADPBeanDisplay (which inherits from Panel). EADP also enforces the use of specialized classForName methods instead of the standard forName method supplied by Java.lang.Class. This standardization is what allows the EADP bean editors to operate consistently and effectively on both the VisualAge and WSAD platforms under the present invention.

The EADPBeanEditor class has a specialLoader attribute, which is set within the WSAD environment to the instance EADPPluginLoader created with the information for the project currently being edited. The EADPBeanDisplay class has a classForNane method which is used uniformly instead of Class.forName to load classes within the special editors. The classForName method uses the EADPPluginLoader if it is available (that is, it uses it when operating within the WSAD environment). Another way that classes can be loaded during the processing of a special editor is via the classForName method in the EADPDataDefinitionClass (for example this is called by managerForName, which is in turned called by a variety of other methods that load the application class (child of EADPApplicationClass) for a particular table). An example of this would be the special editor for quick views (EADPQuickViewDisplay) which needs to find the available columns in the source table for a quick view. It does this by calling anyManagerForTable, which eventually calls classForName on the data definition class.

The classForName method on EADPDatabaseDefinition has the capacity to use a special loader. At run time this is the loader used to find class files stored in a relational database as overrides to the class files found in the jar files supplied with the application. At build time, this invention adds a new attribute, the eclipseLoader, which is assigned an instance of the EADPPluginLoader when operating in the WSAD environment.

Once the code for the encloser has been loaded, bean information system 36 will use bean information from a Java Bean information class corresponding to the encloser to determine properties to display in a property sheet 56 of IDE 50. As was mentioned above, when the EADP property editor is opened for a Java source file in workspace 52, it is passed an Eclipse IFile class. One of the attributes of the class is the file name (relative to the current project). EADP parsing techniques (using the EADPStringReader class) are used to derive the package and class name from this file name. The EADPPluginLoader is then used to load the encloser class, and a default instance is created (as described above). Within the Java Bean standard, information about what properties can be customized as beans is provided by a bean information class. The standard is such that if the class is name “Foo,” the bean information class will be named FooBeaninfo. However, the class being customized as an encloser will not have its own bean information class, rather, it is a child of a standard EADP class which provides the bean information class. For example, the OrdersApplicationClass is a child of EADPApplicationClass, and it uses EADPApplicationClassBeanInfo for its bean information. So the next step, is to find and load the correct bean information class for the encloser. The four most commonly customized types of classes within EADP are the children of EADPApplicationClass, EADPDatabaseDefinition, EADPBftEditor, and EADPServletMonitor. There is also special logic to check if the encloser is an instance of one of the classes, and to set up the corresponding bean information classes. For other classes that may be customized, the procedure is to find the first ancestor that has a bean information class, and use that bean information class. One purpose of finding the bean information class corresponding to the encloser is to find which attributes of the encloser are to be considered customizable beans. Note that this differs from the previous VisualAge technique. In VisualAge (e.g., IDE 60), a bean is manually added to the encloser within the VisualAge visual composition editor and connected to the corresponding attribute of the encloser to open that bean up for customization. This technique does not typically work in WSAD (e.g., IDE 50), since the WSAD visual editor is not capable of defining connections in the same way as the VisualAge visual editor. One of the innovations of this invention is to establish a technique that allows the beans for the encloser to be conveniently and consistently defined. For editor plug-in 30, the way a bean is defined to the encloser is through the encloser's bean information class (the bean is defined as a visible property of the encloser). This step is also a prerequisite to bean usage in VisualAge (e.g., because it makes the encloser property available to connect to the bean added in the visual composition editor). One adjustment made to all the EADP bean information classes for this invention is to make sure that only the properties that should be customized are defined as visible properties of the enclosers' bean information classes. This is needed to ensure proper operation in the WSAD environment.

Once the beans for the encloser have been determined, the next step is to determine what properties for that bean should be displayed in the WSAD outline and property sheet 56. This step is not as straightforward as it may seem, since in some cases is it possible that the bean itself may have been customized to be a child of its original value. One occurrence of this is the connection property of the EADPDatabaseDefinition class. This is defined in EADPDatabaseDefinitionBeanInfo to be of type EADPConnection but this is never the correct answer; the connection needs to be one of the children of EADPConnection (EADPVAPConnection, EADPSimpleConnection or EADPEjbConnection) depending on the persistence mechanism being used. To account for this, the actual value of the bean in the encloser is used to determine the bean's class type (rather than getting the type from the encloser's bean information class). The class type for the bean is then used to find the bean information class for the bean, and this is used to determine which properties for that bean should be included in the outline and property sheet 56 (the visible properties from the bean's bean information class).

Referring back to editor plug-in 30, property determination system 38 will determine Java Bean property values (e.g., for the properties desired to be customized by developer 70) from the code for the Java Bean encloser in workspace 52. Specifically, the Java Bean property values can be derived from the encloser, which can be instantiated using the EADPPluginEditor as described above.

It is important to note that, under the present invention, the Java Bean values need not be stored in some independent format for use by the EADP Property Editor. This in contrast to the VisualAge technique of serializing the bean value and storing it in a central repository. This is also consistent with the WSAD philosophy of making the files evident in the WSAD workspace 52 the sole source of WSAD information, and it makes the bean customization process significantly more robust and reliable than bean customization in VisualAge, which is constantly prone to corruption of the serialized bean values.

The property descriptors in the bean information class include the “get” methods for each property, and these are used (via Java reflection) to find the value for that property in the encloser (or the bean within the encloser). Each bean property has an associated bean editor which is a child of EADPBeanEditor (for properties which do not have a special editor defined the EADPBasicBeanEditor is used). This editor has a “value” attribute. As each property is processed in the bean information class, its value is determined, its editor is instantiated, and the value of the property is assigned into the editor. All of these are held in dictionaries (Java hashtables) for use when that property is edited.

The EADPBeanEditor also has an “eclipseEncloser” property. This is assigned from the current encloser as the property editor is set up for each property. The various property editors that are children of EADPBeanEditor have special editors (children of EADPDisplay) which have the encloser defined as a particular type of attribute and which trigger initialization logic from the assignment of that encloser (for example, for computed columns the encloser is defined to be an instance of EADPApplicationClass, and assigning it to the display panel triggers setting up the list of source columns for the computed fields). Each of these editors had a preexisting mechanism to determine the encloser within the VisualAge environment. These have all been updated to use the eclipseEncloser attribute if it is not null. This provides a consistent and reliable technique to assign the encloser to the special property editors.

Once the applicable Java Bean property values have been determined, they can be edited/customized as desired by developer 70. To this extent, developer 70 can use one or more editors 54 developed for IDE 50 and/or one or more editors developed for IDE 60. Specifically, as indicated above, the present invention allows custom editors developed for IDE 50 to be used in IDE 60. Along similar lines, editor invocation system 40 allows a property editor developed for IDE 50 (e.g., under the Eclipse standard) to be used to invoke a special property editor developed for IDE 60 (e.g. under the Java Bean standard). In particular, the Java Bean standard provides for a special property editor specified by the getCustomEditor method in the property editor class (which implements Java.beans,PropertyEditor). Within VisualAge, EADP makes full use of this feature. However, WSAD follows the Eclipse standard which invokes special editors that are children of an Eclipse class DialogCellEditor. To allow the custom editors from VisualAge (e.g., IDE 60) to be used with WSAD (e.g., IDE 50), a common editor for all EADP controlled properties is provided, namely, the EADPBeanCellDialog which is a child of DialogCellEditor. The EADPBeanCellDialog has as an attribute the bean editor class (child of Java.bean.PropertyEditorSupport) defined by the Java Bean standard. The openDialogBox method is the method invoked within WSAD to open a special editor for a property. As defined for the EADPBeanCell Dialog, it creates a new instance of EADPBeanDialog (which inherits from Java.awt.Dialog and adds Okay and Cancel buttons), and assigns to this dialog the display panel specified by the getCustomEditor method for its bean editor attribute. This is then what is displayed as the custom editor.

In order for this to work properly, the EADPBeanCellDialog is assigned as the custom editor for each property, and the descriptor for each property (within WSAD) has to include the Java Beans custom editor as a attribute. When the specification for the property sheet 56 is set up within WSAD in response to an editor request, what is created is a node of page elements, all of which are instances of classes that inherit from EADPBaseElement. This class has the Java Beans custom editor as an attribute (it is assigned to it as the element is created) and it assigns this editor to its property descriptor, which is an instance of EADPPropertyDescriptor. The property descriptor in turn defines the createPropertyEditor method to return a new instance of EADPBeanCellDialog, with the Java Beans property editor assigned to it as an attribute. It is this linkage that delivers the correct information to the special editors within the WSAD environment.

Another feature of the present invention is provided by editor configuration system 42. Specifically, as depicted, editor plug-in 30 includes editor configuration system 42, which allows developers 70 and the like to design/configure editors that are operable both in IDE 50 and IDE 60. This further enhances the interoperability of the present invention. For example, a common set of EADP code can be used on the two platforms. All enhancements to the EADP property editing classes for WSAD have been tailored to allow the classes to still work properly within VisualAge. Two attributes that have been added for WSAD are the Eclipse encloser and the Eclipse plug-in editor. These will be null in the VisualAge environment, and the code surrounding their usage takes this into account. In addition, under the present invention, custom editors can also be used to access information from related classes within workspace 52.

Regardless, once the applicable property values have been edited/customized, value application system 44 will apply the edited Java Bean property values to the code for the Java Bean encloser. Result storage system 46 can then store the results of the customization (e.g., in storage unit 24) as either updates to source code, updates to one or more extensible markup language (XML) files or both. In general, the Java Bean standard specifies that a Java bean editor (implementing Java.beans.PropertyEditor) must provide a method called getJavaInitializationString. This can then be used to generate out new code in the encloser to reflect the change in the property value. The EADP plug-in uses this same method to generate the code within the WSAD context.

As was mentioned above, when a property editor 56 is displayed within WSAD (e.g., IDE 50), it is within the EADPBeanDialog, which provides Okay and Cancel buttons similar to the ones provided within VisualAge (e.g., IDE 60) in the same context when it brings up a custom editor. In order to get Cancel to work reliably, what happens when the Cancel button is pressed is that the value attribute in the Java Beans custom editor is assigned to be EADPNullObject. If this is returned as a value to the EADPBeanCellDialog (within its openDialogBox method) it assigns the original value (which it saves before opening the custom editor) back into the Java Bean editor and does not invoke a method to update the source code for the encloser. Otherwise, a method is invoked to update the source code for the encloser. The strategy is to update the constructor for the encloser with all the code from the getJavaInitializationString methods for the editor classes for the customized properties. However, there are other issues that can arise:

A. The Source Code is Accessed as a String that can be Modified.

When the editor was invoked, it passed the Java source code as an instance of the Eclipse class IFile. Its getContents method is used to extract the source code.

B. The Constructor Method is Isolated.

The parsing capabilities of EADPStringReader are used extensively here. The name of the class is used to find the declaration of the constructor method within the source code. The “first part” of the code is the code up to this declaration. The “last part” is the code after the ending bracket in the constructor method. The “middle” is the existing code within the constructor, which will be replaced. The technique to find the end of the constructor method (its closing bracket) is to start with the opening bracket and use the upToAny method in EADPStringReader for either and opening or closing bracket. A counter is kept which is incremented when an opening bracket is found and decremented when a closing bracket is found. When this counter reaches zero the current position of the EADPStringReader is at the closing bracket, and its upToEnd method can be used to return the “last part” of the source code.

C. The New Code is Generated for the Property Values.

The basic technique for each property is to access its property editor and Java beans property descriptor. The property descriptor has information about the set method for that property. The property editor getJavaInitializationString method generates the string that should be the parameter to that set method. There is a complication if the property value is not of the same type as that specified by the bean information class (it has been overridden to by a child). In this case a string for a cast back to the original type also needs to be generated to allow the set method to accept the parameter. There are many types of attributes (primitive types such as String, boolean, int and Integer) for which it was not necessary to provide a custom editor in the VisualAge environment. To handle these within the WSAD environment, EADP provides the EADPBeanValue (which holds the primitive value as its “real value”), the EADPBasicBeanEditor which acts as the property editor, and the EADPBasicBeanDisplay which acts as the custom display. The latter just displays an entry field which shows the existing value as a string and allows a string to be entered for the new value. The getJavaInitializationString method in the EADPBasicBeanEditor uses the updates to produce the appropriate string based on the type of the value. Primitive types (int and boolean) are processed internally as arrays to function as Java classes, so there is logic to use the first entry in the array, which is the actual value. There is special logic for boolean to generate a string that says true or false. For type Integer there is logic to generate a string the says new Integer(x) where x is the string representation of the value. These are the only primitive types used as EADP properties that need this special handling.

D. Special Handling for XML Files.

Some properties such as the simple datastore use an XML file instead of Java source code to store the results of bean initialization. One issue here is that although it is certain that the Java source code file exists, the same is not true of the XML file. So the method to write the XML file has to take into account the fact that in may need to either create or update that file.

E. Writing Back the Source Code

The setContents method for the passed IFile is used to update the source code for the encloser. All this happens within the context of a WSAD progress monitor, since this can be a long running process.

It should be understood that the present invention can be realized in hardware, software, or a combination of hardware and software. Any kind of computer system(s)—or other apparatus adapted for carrying out the methods described herein—is suited. A typical combination of hardware and software could be a general purpose computer system with a computer program that, when loaded and executed, carries out the respective methods described herein. Alternatively, a specific use computer, containing specialized hardware for carrying out one or more of the functional tasks of the invention, could be utilized. The present invention can also be embedded in a computer program product, which comprises all the respective features enabling the implementation of the methods described herein, and which—when loaded in a computer system—is able to carry out these methods. Computer program, software program, program, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

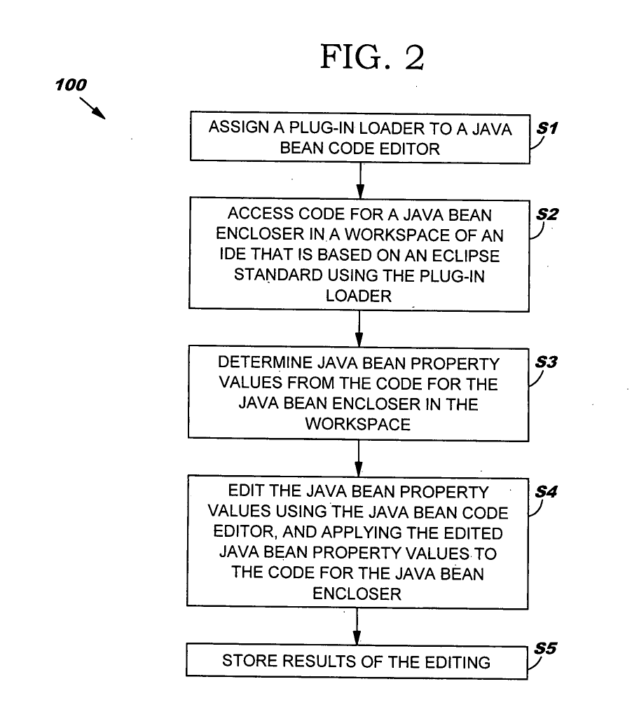

Referring now to FIG. 2, a method flow diagram 100 according to the present invention is depicted. As shown, first step S1 is to assign a plug-in loader to a Java Bean code editor. Second step S2 is to access code for a Java Bean encloser in a workspace of an Integrated Development Environment (IDE) that is based on an Eclipse Standard using the plug-in loader. Third step S3 is to determine Java Bean property values from the code for the Java Bean encloser in the workspace. Fourth step S4 is to edit the Java Bean property values using the Java Bean code editor, and apply the edited Java Bean property values to the code for the Java Bean encloser. Fifth step S5 is to store results of the editing. As indicated above, the results can be stored as updates to source code, or as updates to an XML file(s).

The foregoing description of the preferred embodiments of this invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of this invention as defined by the accompanying claims. For example, the illustrative representations of editor plug-in 3-, IDE 50 and IDE 60 shown in FIG. 1 are not intended to be limiting. That is, the functions of the present invention described herein could be represented by a different configuration of systems.

1. A method for editing Java Bean properties, comprising:
assigning a plug-in loader to a Java Bean code editor;
accessing code for a Java Bean encloser in a workspace using the plug-in loader;
determining Java Bean property values from the code for the Java Bean encloser in the workspace; and
editing the Java Bean property values using the Java Bean code editor, and applying the edited Java Bean property values to the code for the Java Bean encloser.

2. The method of claim 1, further comprising storing results of the editing as updates to Java source code.

3. The method of claim 1, further comprising storing results of the editing as updates to and extensible markup language (XML) file.

4. The method of claim 1, wherein the workspace is implemented within WebSphere Studio Application Developer (WSAD).

5. The method of claim 1, further comprising determining Java Bean property values to display in a property sheet.

6. The method of claim 5, wherein the step of determining property values to display in the property sheet comprises loading the Java Bean encloser in the workspace.

7. The method of claim 1, further comprising invoking at least one special property editor, prior to the editing step.

8. The method of claim 1, wherein the method allows Java Bean property values to be customized within an Integrated Development Environment (IDE) that is based on an Eclipse standard.

9. The method of claim 8, further comprising invoking a property editor developed under a Java Bean standard with an property editor developed under the Eclipse standard.

10. The method of claim 1, further comprising accessing information from at least one class related to the encloser within the workspace using a custom editor.

11. A method for customizing Java Bean properties, comprising:
assigning a plug-in loader to a Java Bean code editor;
accessing code for a Java Bean encloser in a workspace of an Integrated Development Environment (IDE) that is based on an Eclipse Standard using the plug-in loader;
determining Java Bean property values from the code for the Java Bean encloser in the workspace;
editing the Java Bean property values using the Java Bean code editor, and applying the edited Java Bean property values to the code for the Java Bean encloser; and
storing results of the editing.

12. The method of claim 11, wherein the results are stored as updates to source code.

13. The method of claim 11, wherein the results are stored as updates to an XML file.

14. The method of claim 11, further comprising using a custom editor developed for an IDE that is based on a Java Bean standard in the IDE that is based on the Eclipse standard.

15. An editor plug-in for editing Java Bean properties within an Integrated Development Environment (IDE) that is based on an Eclipse standard, comprising:
a loader assignment system for assigning a plug-in loader to a Java Bean code editor;
a code access system for accessing code for a Java Bean Encloser in a workspace using the plug-in loader;
a property determination system for determining Java Bean property values from the code for the Java Bean encloser in the workspace, wherein the Java Bean property values can be edited within the Integrated Development Environment (IDE) using the Java Bean code editor; and
a value application system for applying edited Java Bean property values to the code for the Java Bean encloser.

16. The editor plug-in of claim 15, further comprising a bean information system for determining Java Bean properties values to be displayed in a property sheet based on bean information from a Java Bean information class corresponding to the encloser.

17. The editor plug-in of claim 15, further comprising an editor invocation system for invoking a property editor developed under a Java Bean standard with a property editor developed under the Eclipse standard.

18. The editor plug-in of claim 15, further comprising a result storage system for storing results of edits to the property values occurring within the workspace as updates to source code or as updates to an XML file.

19. The editor plug-in of claim 15, further comprising an editor configuration system for providing editors that are operable in an integrated development environment (IDE) that is based on a Java Bean standard and in the IDE that is based on the Eclipse standard.

20. The editor plug-in of claim 15, wherein the property determination system loads the encloser into the workspace.

21. The editor plug-in of claim 20, wherein the property determination system further assigns correct property values of the encloser to a custom editor.

22. The editor plug-in of claim 15, wherein custom editors developed for an IDE that is based on a Java Bean standard are operable within the IDE that is based on the Eclipse standard.

23. A program product stored on a recordable medium for editing Java Bean properties within an Integrated Development Environment (IDE) that is based on an Eclipse standard, comprising:
program code for assigning a plug-in loader to a Java Bean code editor;
program code for accessing code for a Java Bean Encloser in a workspace using the plug-in loader;
program code for determining Java Bean property values from the code for the Java Bean encloser in the workspace, wherein the Java Bean property values can be edited within the Integrated Development Environment (IDE) using the Java Bean code editor; and
program code for applying edited Java Bean property values to the code for the Java Bean encloser.

24. The program product of claim 23, further comprising a program code for determining Java Bean properties values to be displayed in a property sheet based on bean information from a Java Bean information class corresponding to the encloser.

25. The program product of claim 23, further comprising program code for invoking a property editor developed under a Java Bean standard with a property editor developed under the Eclipse standard.

26. The program product of claim 23, further comprising program code for storing results of edits to the property values occurring within the workspace as updates to source code or as updates to an XML file.

27. The program product of claim 23, further comprising program code for providing editors that are operable in an integrated development environment (IDE) that is based on a Java Bean standard and in the IDE that is based on the Eclipse standard.

28. The program product of claim 23, wherein the program code for determining loads the encloser into the workspace.

29. The program product of claim 28, wherein the program code for determining further assigns correct property values of the encloser to a custom editor.

30. The program product claim 23, wherein custom editors developed for an IDE that is based on a Java Bean standard are operable within the IDE that is based on the Eclipse standard.
